(19) United States
(12) Patent Application Publication
(10) Pub. No.: US 2025/0092218 A1
(43) Pub. Date: Mar. 20, 2025

(54) ACIDOLYSIS OF POLYURETHANE TO POLYOL PRODUCTS

(71) Applicants: Dow Global Technologies LLC, Midland, MI (US); THE REGENTS OF THE UNIVERSITY OF CALIFORNIA, Oakland, CA (US)

(72) Inventors: Zachary Westman, Goleta, CA (US); Baoyuan Liu, Santa Barbara, CA (US); Kelsey Richardson, Goleta, CA (US); Christopher S. Letko, Pearland, TX (US); Phillip Christopher, Santa Barbara, CA (US); Mahdi M. Abu-Omar, Santa Barbara, CA (US); Paul A. Gillis, Lake Jackson, TX (US); Thomas C. Farmer, Houston, TX (US); Vojtech Vlcek, Goleta, CA (US)

(21) Appl. No.: 18/828,604

(22) Filed: Sep. 9, 2024

Related U.S. Application Data
(60) Provisional application No. 63/539,131, filed on Sep. 19, 2023.

(51) Int. Cl. C08J 11/26

(52) U.S. Cl. CPC C08J 11/26; C08J 2375/08

(57) ABSTRACT

Repolyols can be quickly produced by combining fragments of a polyurethane product which with a reagent which is an organic acid or an anhydride of the organic acid or a mixture thereof to form a reaction mixture, and heating the reaction mixture to a reaction temperature greater than a melting point of the reagent for a reaction time of no greater than two hours. The organic acid comprises two carboxylic acid groups linked to each other through a linking group having two or three carbon atoms in the linking chain. The anhydride can include a 5 or 6 member cyclic structure with the group —C(O)—O—C(O)—.

This application claims the benefit of priority under 35 U.S.C. § 119 (e) of U.S. Provisional Patent Application No. 63/539,131 filed on Sep. 19, 2023.

### FIELD OF THE INVENTION

This invention relates to a method of recycling polyurethanes, particularly flexible polyurethane foams, using acidolysis to produce polyols products.

### BACKGROUND OF THE INVENTION

Recycling of polymeric materials can be an important approach to reducing plastic waste and also reducing raw material supply demand.

As thermosetting material, recycling of polyurethanes typically involves chemolysis (or decomposition to simpler and/or smaller compounds).

Past approaches to chemolysis of polyurethanes can require several hours of digestion (reaction) time at elevated temperatures to generate a re-polyol and/or require three or more components in the reaction mixture. As used herein a re-polyol means a polyol produced by recycling or polyurethane.

Thus, it would be desirable to have an efficient, simple, and/or rapid means of converting polyurethane foams to re-polyols.

### SUMMARY OF THE INVENTION

Disclosed herein is a method of producing polyols from a recycle product comprising a polyurethane. The method includes combining fragments of a polyurethane product which comprises a polyurethane with a reagent which is an organic acid or an anhydride of the organic acid or a mixture thereof to form a reaction mixture, and heating the reaction mixture to a reaction temperature greater than a melting point of the reagent for a reaction time of no greater than two hours, preferably no greater than one hour, to produce a reaction product comprising one or more polyols, one or more polyesters, or a mixture thereof. The organic acid comprises two carboxylic acid groups covalently bonded via a divalent linking group, the divalent linking group comprises a structure of formula (I) or formula (II)

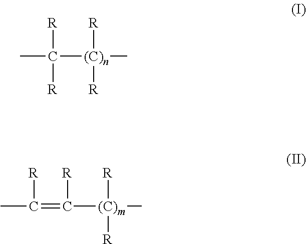

wherein n is 0, 1 or 2; m is 0 or 1; and R is independently in each occurrence H, or an alkyl of 1, 2, or 3 carbon atoms, or two R on adjacent carbon atoms taken together form an alicyclic ring or an aromatic ring. The anhydride includes a cyclic structure comprising the linking group of formula I or II with —C(O)—O—C(O)—.

### DETAILED DESCRIPTION OF THE INVENTION

It was discovered that a surprisingly rapid conversion of polyurethanes to polyesters and/or polyols could be achieved by selection of certain types of organic acids (or anhydrides thereof) as the reagent. This rapid reaction could surprisingly be achieved using only conventional heating (i.e., no radiation heating such as microwave was needed). The rapid reaction could also surprisingly be efficiently performed without addition of virgin polyol or ionic liquids to assist in the digestion of the polyurethane.

A polyurethane product to be recycled is combined with a reagent to form a reaction mixture. The reaction mixture is heated to cause chemolysis (particularly, acidolysis) of the polyurethane.

The polyurethane product comprises a polyurethane as the major component. For example, the polyurethane product can comprise greater than 50, greater than 60, greater than 70, greater than 80, or greater than 90 and up to 100, up to 99, up to 98, up to 97, up to 96, or up to 95 weight percent of polyurethane. The remainder of the polyurethane product may include one or more additives (e.g., fillers); impurities; other polymers that had been mixed or blended with the polyurethane; residual amounts adjacent layers such as metal foils, or polymers or moisture. The polyurethane can be any polyurethane which is desired to be recycled. For example, the polyurethane can be a polyether polyurethane. The polyurethane product to be recycled can be, for example, a flexible polyurethane foam. For example, a polyurethane product, such as a flexible polyurethane foam, can comprise 0 to 6, 1 to 5.5, or 2-5% residual moisture based on total weight of the polyurethane foam.

For efficient mixture, the polyurethane can be provided to the reaction mixture in the form of fragments. For example, a polyurethane source (e.g., a flexible polyurethane foam) can be cut into pieces and then shredded or chopped to form fragments. The size of the fragments can be, for example, from 0.1, from 0.5, or from 1 up to 100, up to 50, up to 10, or to up 5 millimeters.

The reagent comprises an organic acid or an anhydride thereof. The organic acid comprises two carboxylic acid groups. These two carboxylic acid groups (—COOH) are covalently bonded through a divalent linking group such that there are no more than three atoms in a chain between the carbon atoms of the carboxylic acid groups. The divalent linking group can have a formula (I) or a formula (II):

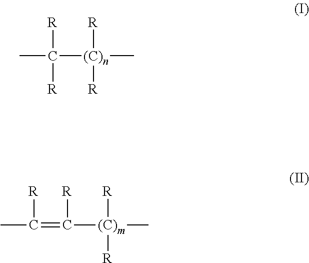

wherein n is 0, 1, or 2, preferably 0; m is 0 or 1, preferably 0. R can be independently in each occurrence H, an alkyl group (preferably an alkyl group of 1, 2, or 3, more preferably 1, carbon atoms), or two R taken together (preferably R on adjacent carbon atoms) can form a cyclic structure (preferably an aromatic ring) including the carbon atoms to which they are attached. A combination of two or more such organic acids, two or more such anhydrides or a combination of one or more such organic acids with one or much such anhydrides can be used.

When the reagent is an anhydride the reaction mixture includes some water to convert the anhydride to the corresponding diacid to facilitate the acidolysis reaction. The amount of water can from 0.03, from 0.05, from 0.1, from 0.2, from 0.3, from 0.4, from 0.5, from 0.7, from 1% up to 6%, up to 5%, up to 4%, or up to 3% based on total weight of the polyurethane in the polyurethane product. Having too much water in the reaction mixture is undesirable. For example, the reaction generally occurs above the boiling point of water so excess water simply requires additional energy. Excess water can also hinder or quench the reaction. Since the polyurethane product (e.g., polyurethane foam) may include residual moisture, it may not be necessary to add additional water to the reaction mixture. When the reagent is an acid, the presence of water is optional, but water can be present in amounts of 0-6%, 0.03 to 5%, 0.1 to 4%, 0.2 to 3%, 0.3 to 2%.

The reagent can consist of such organic acid(s) and/or anhydride(s) without other reactive species. Alternatively, the reagent could include other organic acids or anhydrides, such as monoacids, or other diacids. However, inclusion of such other organic acids or anhydrides may slow the reaction time.

The reagent can be, for example, maleic acid, phthalic acid, homophthalic acid, succinic acid, glutaric acid, 2-methyl glutaric acid, 3-methyl glutaric acid, phthalic anhydride, succinic anhydride, or a combination of two or more thereof.

Optionally the organic acid can comprise one or more additional carboxylic acid groups (e.g., a tri-acid).

The reagent is in liquid form at the reaction temperature. Thus, the reaction temperature is greater than a melting temperature of the organic acid and/or anhydride thereof. The reagent can be heated to greater than its melting temperature before being combined with the polyurethane. Alternatively, the reagent in a solid form can be combined with the polyurethane and then heated to a temperature of above the melting point of the reagent.

The reaction mixture can be free of or substantially free of additional reactive species. The reaction mixture can be free of or substantially free of added polyols. (Note that some polyols will form during the reaction. However, the reaction mixture is initially free of polyols). For example, the initial reaction mixture can have added polyols in amounts of less than 0.1, less than 0.05, less than 0.02, less than 0.01, or can have 0 parts by weight per part by weight of polyurethane. The reaction mixture can be free of or substantially free of catalyst. For example, the reaction mixture can have catalyst in amounts of less than 0.001 or, less than 0.0005, less than 0.0002, less than 0.0001, or can have 0 parts by weight per part by weight of polyurethane. The reaction mixture can be free of or substantially free of additional liquids such as ionic liquids or solvents. For example, the reaction mixture can have less than 5, less than 1, less than 0.5, less than 0.1 or can have 0 parts be weight additional liquid per 1 part by weight of the reagent.

The reaction occurs at a reaction temperature above the melting point of the reagent. For example, the reaction can occur at a temperature of greater than 135° C., or at least 140° C., or at least 150° C. Desirably, the reaction temperature is also less than about 210° C., less than 200° C., less than 190° C., less than 185° C., less than 180° C., or less than 175° C. Higher temperatures can cause undesired side reactions and decomposition of the polyurethane product being recycled (e.g., the polyurethane foam).

The reaction time can be less than 2 hours, no greater than 1 hour, no greater than 45 minutes or no greater than 30 minutes. At the same time, the reaction time can be at least 2 minutes, at least 5 minutes, or at least 10 minutes. The reaction time can be from the time the reaction mixture is at the reaction temperature to a time when it is quenched. For example, the quench can occur by reducing the temperature to a temperature below the melt temperature of the reagent. For example, the quench temperature can be less than 135° C., or no greater than 110 or no greater than 100° C. . . . As another example, quench can occur by addition of aqueous base to neutralize the acid reagent.

The reaction mixture can be heated by conventional means. No radiation (e.g., microwave radiation) is needed to a rapid acidolysis of the polyurethane. The reaction can be stirred during the reaction.

The completion of the reaction can be determined, for example, by monitoring the amount of carbon dioxide produced by the reaction. For example, when the reaction ceases to produce carbon dioxide or when the amount and/or rate of carbon dioxide being produced becomes low, the reaction is at or near completion. For example, carbon dioxide evolution in a sealed reaction system could be monitored indirectly by when the pressure stops increasing. Alternatively, carbon dioxide evolution can be monitored by an analysis method such as gas chromatography (GC), mass spectroscopy (MS), Fourier transform infrared spectroscopy (FTIR), a non-dispersive infrared carbon dioxide sensor (NDIR CO2 sensor), or any kinds of carbon dioxide monitors/testers (i.e., calcium cation liquids equipped with gas diffusion).

The reaction as disclosed herein can proceed quickly. For example, the time to reach half completion (e.g., when half of the total evolved carbon dioxide indicating completion of the reaction is produced) can be less than 10, less than 8, less than 5, or less than 2 minutes. As another example, the time to 95% completion (e.g., when 95% of the evolved carbon dioxide indicating completion of the reaction is produced) can be less than 30, less than 25, less than 20, less than 15, less than 10, or less than 5 minutes. Thus, the reaction can be readily completed or substantially completed (e.g., at least 90, at least 95, or at least 99% complete) in the reaction time.

A determination of when to quench the reaction can be based on a set desired reaction time. Alternatively, a determination of when to quench the reaction can be based on monitoring of the amount of evolved carbon dioxide. For example, when the rate of production of carbon dioxide begins to approach zero, the reaction can be quenched. For example, quench can begin when the rate of carbon dioxide is less than 0.05, less than 0.01, or less than 0.005 ml carbon dioxide per minute per gram of reaction mixture. As another example, when the reaction is nearing completion can be based on an anticipated volume of evolved gas. The anticipated volume can be determined, for example, empirically from prior experience with similar polyurethane products to be recycled or theoretically based on a presumed composition of the polyurethane product.

The liquid from the reaction can be isolated from any solids such as any residual reagent (in solid form after cooling below its melting point) and any residual solids from the polyurethane (this could include, for example, additives such as particulates, fillers, or catalysts used in the polyurethane which is being recycled). The liquid reaction product can include polyols, polyesters, amides, imides, excess entrapped acid or a mixture thereof. The polyesters can be hydrolyzed to form polyols. The liquid reaction product (prior to any hydrolysis) can have a purity

$$( purity = \frac{{mass}_{polyol} + {mass}_{polyester}}{{mass}_{liquid reaction product}} * 100 \% , )$$

of greater than 50%, greater than 70%, or greater than 80%. The purity can be up to 95%, or up to 90%.

Overall yield is based on mass of the polyurethane product being recycled is the mass of polyol plus the mass of polyesters and polyols in the liquid reaction divided by the mass of polyurethane product

$$( yield = \frac{{mass}_{polyol} + {mass}_{polyester}}{{mass}_{polyurethan product}} * 100 \% ) .$$

This overall yield will depend upon the chemical structure of the polyurethane and any additives (e.g., fillers) that may be present in the polyurethane product being recycled. The method can produce an overall yield of greater than 40%, greater than 50%, or greater than 60% based on weight of polyurethane being recycled. This yield is impacted by the relative amount of polyol derivative in the polyurethane being recycled. Where the amount of polyol derivative in the polyurethane being recycled is known a yield relative to theoretical maximum yield can be calculated. This yield relative to theoretical maximum is the mass of polyols and plus the mass of polyesters in the liquid reaction product divided by the mass of polyol derivative in the polyurethane. The mass of the polyol derivative in the polyurethane can be known, calculated or approximated from knowledge of the specific composition of the polyurethane, published information regarding the structure of the polyurethane (e.g., product literature) or by chemical analysis using a method such as quantitative Carbon-13 nuclear magnetic resonance (13C NMR). The yield relative to theoretical maximum can be greater than 60%, greater than 70%, greater than 80% or greater than 90%. The mass of polyol and polyester produced can be measured for example by separation and weighing or be use of an analytical technique such as quantitative 13C NMR.

Yield may increase as the mass ratio of polyurethane to the reagent decreases up to ratios of about 1:3, 1:4 or 1:5. Purity may decrease as the mass ratio of polyurethane to reagent increases. For a balance of yield and purity, a mass ratio of the polyurethane: the reagent can be, for example, from 1:0.25, from 1:0.3, from 1:0.3.1, from 1:0.32, from 1:0.33, from 1:0.35, or form 1:0.4 up to 1:2, up to 1:1, up to 1:0.8, up to 1:0.7, up to 1:0.6, or up to 1:0.55.

The method can include hydrolysis of any polyesters in the liquid reaction product to polyols. The method can include separation steps to isolate the polyols. The order of the hydrolysis and separation steps can vary.

For example, an aqueous base can be added directly to liquid reaction product. This can be after the reaction is thermally quenched. The addition of the aqueous base can itself quench the reaction by neutralizing the reagent. The aqueous base can hydrolyze any polyesters in the liquid reaction product to polyols.

For example, at the end of the acidolysis reaction an aqueous base (e.g., NaOH (aq)) solution can be added (e.g., at a 1:1 molar ratio, or 1:1.5 ratio of OH: —COOH from the reagent used in the acidolysis reaction). The temperature can be lowered from the reaction temperature but maintained at a temperature to reflux (e.g., about 100° C., 12° C., or 150° C.) to cause the hydrolysis of the polyesters. After hydrolysis, the mixture can be cooled, washed and separated by liquid-liquid extraction methods (e.g., in a separatory vessel or flask with addition of water and an organic solvent such as toluene. The polyol product is isolated in the organic solvent (e.g., toluene) layer while the other impurities and by-products are removed and stayed in the aqueous phase.

Any solids not previously removed after hydrolysis can be removed by mechanical separation (e.g., filtering, centrifuge, settling, etc.). The polyols can then be separated by liquid/liquid extraction. Prior to the liquid-liquid extraction, the pH of hydrolysis solution can stay as is, or can be tuned to a favorable pH range (i.e., pH 5, 6, 7, or 8) to minimize the emulsion between organic and aqueous layers. A centrifugation method can be combined with this liquid-liquid extraction strategy to accelerate and enhance the organic layer separation from the aqueous phase. G-force of centrifuge used, can be from less than 100, or less than 200, or less than 500, or less than 1000, or up to 3000. The neat polyol product is collected after separating the toluene phase and evaporating the toluene solvent.

As another example, one may first undertake one or more separation steps. If a thermal quench is used any remainder of acid reagent can solidify. Such solidified reagent and any solid components from the polyurethane product can be removed. The liquid portion can be separated by liquid/liquid extraction. Hydrolysis can then be performed.

For example, the liquid reaction product can be dissolved in organic solvent (e.g., ethyl acetate) and mixed well with sodium hydroxide aqueous solution. The phases can be separated—e.g., using centrifugation and tube separation. A top phase includes ethyl acetate solvent containing polyol, polyesters, and amides products, the middle phase includes polyol products with some water/ethyl acetate mixture, the bottom phase contains leftover excess maleic acid, disodium maleate, and other by-products. The phases including polyols can be combined and dried to remove ethyl acetate and water.

The hydrolysis can be for example a three step process including (1) separating the polyol middle phase from centrifugation, (2) subjecting the collected polyol to liquid-liquid extraction (for example, in ethyl acetate) followed by solvent removal and drying; and (3) refluxing the dried polyol product in an acidic basic solution (e.g., NaOH (aq)). The amount of OH⁻ can be in 1:1 or 1:1.5 molar ratio with respect to the total-COOH from the reagent used in the acidolysis reaction).

Alternatively, the hydrolysis can involve two steps and be performed on the crude rection mixture (liquid reaction product) bypassing centrifugation.

### EXAMPLES

### General Procedure

Flexible polyurethane foam (1 cubic meter size) was first cut into smaller pieces (approximate 10×5×5 centimeters (cm)). The small piece of polyurethane foam was immersed in liquid nitrogen and fully wetted with liquid nitrogen to increase its brittleness. Next, the frozen polyurethane foam was placed in a grinder equipped with cross blades. After 10 seconds of grinding, the resultant PU foam shreds appeared as a fine white powder with particle size between 500-2000 micrometers. FT-IR before and after grinding showed that this physical treatment did not chemically decompose the polyurethane foam.

The acidolysis reaction was carried out in a round bottom flask (or a glass vessel) equipped with magnetic stirring and heated by homogeneous oil bath to the desired reaction temperature. For each reaction, the shredded polyurethane foam was directly added into the flask and mixed with the acidolysis reagent. The mixture was heated in an oil bath while stirring. The CO₂ produced was collected and isolated as calcium carbonate and its mass quantified.

### Example 1

For maleic acid as the reagent at 175° C. the total amount of CO₂ collected at 1 minute was about 5 milliliters (mL), the amount collected at 2 minutes was about 11 mL, the amount collected at 5 minutes was about 15 mL, the amount collected at 10 minutes was 17.6 mL at 10 minutes, while the total amount at 60 minutes was only 18.1 mL. This indicates that the reaction was substantially completed in the first 10 minutes as the rate of evolution of carbon dioxide decreased during the time between 5 and 10 minutes and even more substantially decreased after 10 minutes.

### Example 2

Using maleic acid as the reagent reacted at 175° C., the mass ratio of a known polyurethane to maleic acid was varied. The weight of the polyols and polyesters produced was determined by quantitative 13C NMR. Since the polyurethane was known material of known structure, a yield of based on the known amount of polyol derivative in the polyurethane was determined. (Yield vs. theoretical maximum=100×(weight of polyols and polyesters in the liquid product mixture divided by the weight of polyol used in synthesizing the polyurethane). The yield based on weight of initial polyurethane was also determined as 100×(weight of polyols and polyesters in the liquid product divided by the initial weight of polyurethane product). A purity of the liquid reaction product (Purity=100×(polyol+polyesters weight)/overall weight of liquid reaction). The results are as shown in Table 1.

TABLE 1

| | Yield vs | Yield based | |
|---|---|---|---|
| Mass ratio | theoretical | on initial | |
| polyurethane:maleic | maximum | weight of | |
| acid | (%) | polyurethane (%) | Purity (%) |
| 1:0.2 | 17 | 12 | 97 |
| 1:0.33 | 72 | 50 | 90 |
| 1:0.5 | 93 | 64 | 83 |
| 1:1 | 98 | 68 | 41 |
| 1:2 | 100 | 69 | 30 |
| 1:6 | 98 | 68 | 20 |

### Examples 3-11 and Comparative Examples A-D

Various reagents were tested as shown in Table 2. The amount of carbon dioxide produced was monitored throughout the reaction. The reaction was stopped when no gas evolution was observed for five minutes. The time at which ½ of the total carbon dioxide produced has been produced is t_{1/2}. The time at which 95% of the total carbon dioxide had been produced is t at 95% completion.

TABLE 2

| | | | Melting | | | |
|---|---|---|---|---|---|---|
| | | | Temp of | | | t at 95% |
| | | | Reagent | Mass ratio | t_{1/2} | completion |
| | Reagent | Structure | (° C.) | (PU:reagent) | (sec) | (sec) |
| 3 | Maleic acid | 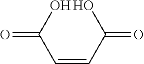 | 135 | 1:3 | 75 | 215 |
| 4 | Phthalic acid | 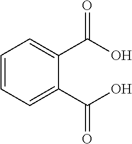 [SMILES: O=C(O)c1ccccc1C(=O)O] | 207 | 1:3 | 260 | 495 |
| 5 | Homophthalic acid | 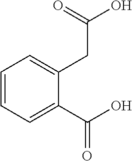 [SMILES: O=C(O)Cc1ccccc1C(=O)O] | 181 | 1:3 | 245 | 460 |
| 6 | Succinic acid | 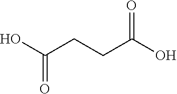 | 185 | 1:3 | 190 | 440 |
| 7 | Glutaric acid | 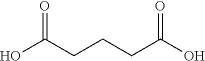 | 98 | 1:3 | 470 | 1440 |
| 8 | 2-methyl glutaric acid | 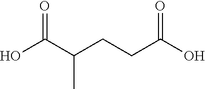 | 80 | 1:3 | 475 | 1365 |
| 9 | 3-methyl glutaric acid | 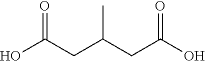 | 81 | 1:3 | 380 | 1135 |
| 10 | Phthalic anhydride | 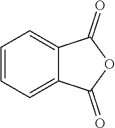 [SMILES: O=C1OC(=O)c2ccccc21] | 132 | 1:3 | 275 | 925 |
| 11 | Succinic anhydride | 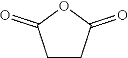 | 119 | 1:3 | 440 | 1260 |
| A | Adipic acid | 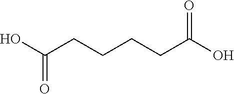 | 152 | 1:3 | 2845 | 7625 |
| B | Pimelic acid | 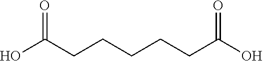 [SMILES: O=C(O)CCCCCC(=O)O] | 105 | 1:3 | 2840 | 7920 |
| C | Hexanoic acid | 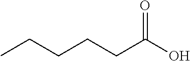 | -3 | 1:6 | 5835 | 14780 |
| D | Benzoic acid | 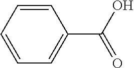 | 122 | 1:6 | 31500 | 60000 |

### Example 12—Purification and Isolation

After the acidolysis reaction using maleic anhydride, the liquid acidolysis product was be purified via treatment with an aqueous NaOH solution (20-25 mL) containing the equivalent or slightly higher molar ratio of [OH—] to the reactant dicarboxylic acid [COOH] was added to the product mixture. In this step, the reaction mixture was quenched by lowering the temperature from acidolysis temperature to 100° C. After 30 min of reflux at 100° C., the polyol-acid ester bond is cleaved, and the hydroxyl end groups recovered through hydrolysis. Once the reaction mixture cooled to room temperature, the products were washed with 35 mL ethyl acetate and transferred to a 250 mL separatory funnel with additional 100 mL of water. After leaving the mixture in separatory funnel overnight, it was divided into two layers. The top layer was the ethyl acetate phase which contained recycled polyol, minor amide byproduct, and some residual acids. The bottom layer was the aqueous phase which contained the majority of amide, acid, and other minor byproducts (if any, i.e., amines). The top ethyl acetate layer was collected from the separatory funnel and divided into four 50 mL plastic centrifuge tubes (about 8-9 mL ethyl acetate solution in each tube). Next, the tubes were filled with water to 45 mL total volume and neutralized to a pH 7 by adding HCl. After centrifugation at 7000 rpm for 25 min, a clean-cut of ethyl acetate layer was separated as the top layer in each tube. This layer was carefully removed and combined in a 100 mL round bottom flask. After removal of ethyl acetate by rotary evaporation, the purified recycled polyol was isolated. A further purification of recycled polyol can be done by using toluene solvent. By which, to the dried recycled polyol, an equal volume of toluene and water mixture was employed that can sufficiently wash the recycled polyol into a separatory funnel. The toluene phase containing further purified recycled polyol was separated from water phase into a round bottom flask. After removal of toluene, the dried and further purified recycled polyol was collected.

¹³C Nuclear Magnetic Resonance (13C NMR) Spectroscopy was done with a Bruker Avance NEO 500 MHz spectrometer which was equipped with a 5 mm X-nuclei optimized double resonance cryoprobe. For each measurement, 100-150 mg samples were dissolved in 600 μ DMSO-d₆ and packed in a 5 mm glass tube. For quantitative ¹³C NMR, 100 μL 25 mM Cr(acac)₃ was added to 150 mg sample with 600 μL DMSO-d₆ in the 5 mm NMR glass tube A. ¹³C NMR of virgin polyol, purified re-polyol from model foam, and re-polyol from end-of life foam were obtained. The 13C NMR spectra confirm that our invention successfully produced re-polyol with the same chemical shifts as virgin polyol.

This disclosure further encompasses the following aspects.

Aspect 1. A method of comprising combining fragments of a polyurethane product which comprises a polyurethane with a reagent which is an organic acid or an anhydride of the organic acid or a mixture thereof to form a reaction mixture, heating the reaction mixture to a reaction temperature greater than a melting point of the reagent for a reaction time of no greater than two hours, preferably no greater than one hour, more preferably no greater than 30 minutes, yet more preferably no greater than 20 minutes, and still more preferably no greater than 10 minutes, to produce a reaction product comprising one or more polyols, one or more polyesters, or a mixture thereof, wherein the reagent is a liquid at the reaction temperature and wherein the organic acid comprises two carboxylic acid groups covalently bonded via a divalent linking group, the divalent linking group comprises a structure of formula (I) or formula (II)

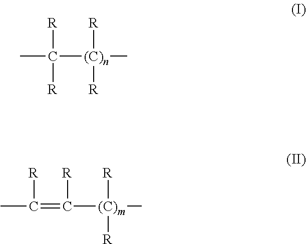

wherein n is 0, 1 or 2; m is 0 or 1; and R is independently in each occurrence H, or an alkyl of 1, 2, or 3 carbon atoms, or two R on adjacent carbon atoms taken together form an alicyclic ring or an aromatic ring.

Aspect 2. The method of Aspect 1 wherein the reaction time is at least 2 minutes, preferably at least 5 minutes, more preferably at least 10 minutes.

Aspect 3. The method of Aspect 1 or 2 wherein the reaction mixture is substantially free of added polyols.

Aspect 4. The method of any one of the previous Aspects wherein the reaction mixture is substantially free of additional liquid.

Aspect 5. The method of any one of the previous Aspects wherein the reaction mixture is free of reaction catalyst.

Aspect 6. The method of Aspect 1 or 2 wherein the reaction mixture initially consists of the fragments of the polyurethane product and the reagent, and optionally up to 6 wt. % water based on weight of the fragments of the polyurethane product.

Aspect 7. The method of any one of the previous Aspects wherein the polyurethane product comprises a polyether polyurethane.

Aspect 8. The method of any one of the previous Aspects wherein the polyurethane product is a flexible polyurethane foam.

Aspect 9. The method of any one of the previous Aspects wherein the reagent comprises maleic acid, phthalic acid, homophthalic acid, succinic acid, glutaric acid, 2-methyl glutaric acid, 3-methyl glutaric acid, phthalic anhydride, succinic anhydride, or a combination of two or more thereof.

Aspect 10. The method of any one of the previous Aspects wherein the reagent is maleic acid.

Aspect 11. The method of any one of the previous Aspects wherein a weight ratio of the polyurethane: the reagent in the reaction mixture is from 1:0.3 to 1:0.8, preferably 1:0.31 to 1:0.7, more preferably 1:0.32 to 1:0.6, yet more preferably 1:0.33 to 1:0.55.

Aspect 12. The method of any one of the previous Aspects wherein heating is done by convection, conduction or a combination thereof.

Aspect 13. The method of any one of the previous Aspects wherein the reaction is at least 90% completed as indicated by CO₂ produced in the reaction time.

Aspect 14. The method of any one of the previous Aspects wherein the reaction product comprises at least 60, preferably at least 70, more preferably 80 weight percent of the one or more polyols based on total weight of the reaction product.

Aspect 15. The method of any one of the previous Aspects further comprising separating the one or more polyols from the reaction product.

Aspect 16. The method of any one of the previous Aspects further comprising exposing the reaction product to an aqueous base to hydrolyze polyesters in the reaction product to polyols.

Aspect 17. The method of Aspect 16 wherein after hydrolyzation the polyols are separated and purified.

Aspect 18. The method of anyone of the previous Aspects wherein the mass yield of the one or more polyols and the one or more polyesters is at least 70, preferably at least 80, and more preferably at least 90 wt. % based on the mass of polyol derivatives in the polyurethane product.

Aspect 19: The method of any one of the previous Aspects wherein the reaction temperature is at least 135° C., preferably at least 140° C. and less than 200° C., preferably less than 190° C., more preferably less than 185° C., yet more preferably less than 180° C., and still more preferably less than 175° C.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). Moreover, stated upper and lower limits can be combined to form ranges (e.g., “at least 1 or at least 2 weight percent” and “up to 10 or 5 weight percent” can be combined as the ranges “1 to 10 weight percent”, or “1 to 5 weight percent” or “2 to 10 weight percent” or “2 to 5 weight percent”).

The disclosure may alternately comprise, consist of, or consist essentially of, any appropriate components herein disclosed. The disclosure may additionally, or alternatively, be formulated so as to be devoid, or substantially free, of any components, materials, ingredients, adjuvants or species used in the prior art compositions or that are otherwise not necessary to the achievement of the function and/or objectives of the present disclosure.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

Unless specified to the contrary herein, all test standards are the most recent standard in effect as of the filing date of this application, or, if priority is claimed, the filing date of the earliest priority application in which the test standard appears.

What is claimed is:

1. A method comprising
combining fragments of a polyurethane product which comprises a polyurethane with a reagent which is an organic acid or an anhydride of the organic acid or a mixture thereof to form a reaction mixture,
heating the reaction mixture to a reaction temperature greater than a melting point of the reagent for a reaction time of no greater than two hours to produce a reaction product comprising one or more polyols, one or more polyesters, or a mixture thereof, wherein the reagent is a liquid at the reaction temperature and wherein the organic acid comprises two carboxylic acid groups covalently bonded via a divalent linking group, the divalent linking group comprises a structure of formula (I) or formula (II) 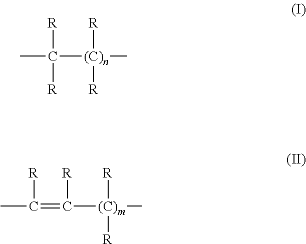
wherein n is 0, 1 or 2; m is 0 or 1; and R is independently in each occurrence H, or an alkyl of 1, 2, or 3 carbon atoms, or two R on adjacent carbon atoms taken together form an alicyclic ring or an aromatic ring.

2. The method of claim 1 wherein the reaction mixture is substantially free of added polyols.

3. The method of claim 1 wherein the reaction mixture is substantially free of additional liquid.

4. The method of claim 1 wherein the reaction mixture is free of reaction catalyst.

5. The method of claim 1 wherein the reaction mixture initially consists of the fragments of the polyurethane product and the reagent, and optionally up to 6 wt. % water based on weight of the fragments of the polyurethane product.

6. The method of claim 1 wherein the polyurethane product comprises a polyether polyurethane.

7. The method of claim 1 wherein the polyurethane product is a flexible polyurethane foam.

8. The method of claim 1 wherein the reagent comprises maleic acid, phthalic acid, homophthalic acid, succinic acid, glutaric acid, 2-methyl glutaric acid, 3-methyl glutaric acid, phthalic anhydride, succinic anhydride, or a combination of two or more thereof.

9. The method of claim 1 wherein a weight ratio of the polyurethane: the reagent in the reaction mixture is from 1:0.3 to 1:0.8.

10. The method of claim 1 wherein heating is done by convection, conduction or a combination thereof.

11. The method of claim 1 wherein the reaction is at least 90% completed as indicated by CO₂ produced in the reaction time.

12. The method of claim 1 wherein the reaction product comprises at least 60 weight percent of the one or more polyols based on total weight of the reaction product.

13. The method of claim 1 further comprising exposing the reaction product to an aqueous base to hydrolyze polyesters in the reaction product to polyols.

14. The method of claim 1 further comprising separating the one or more polyols from the reaction product.

15. The method of claim 1 wherein the mass yield of the one or more polyols and the one or more polyesters based on the mass of polyol derivatives in the polyurethane product is at least 70 wt. %.
